(19) United States
(12) Patent Application Publication
(10) Pub. No.: US 2016/0269066 A1
(43) Pub. Date: Sep. 15, 2016

(54) IMPACT-RESISTANT CELL PHONE

(71) Applicant: WEIYOU TECHNOLOGY CO., LIMITED, HONG KONG (HK)

(72) Inventor: XIU QIN ZHANG, HONGKONG (HK)

(21) Appl. No.: 14/656,613

(22) Filed: Mar. 12, 2015

(51) Int. Cl. H04B 1/3888

(52) U.S. Cl. CPC H04B 1/3888

(57) ABSTRACT

An impact-resistant cell phone includes a body and a processor. The processor is arranged in the body. The body includes a display face and a back face opposite to the display face. The cell phone also includes a crash-proof protective part, a falling detection unit and an angular adjustment unit. The crash-proof protective part is arranged on the body. The falling detection unit and the angular adjustment unit are arranged in the body and respectively connected with the processor. The processor is used for receiving and processing information from the falling detection unit. And the angular adjustment unit is used for adjusting the spatial angle of the cell phone according to the control information transmitted from the processor. The impact-resistant cell phone has the advantages that the cell phone can be protected from being damaged due to falling.

### BACKGROUND OF THE INVENTION

1. Field of the Invention

The present invention relates to the field of electronic products, in particular to a cell phone capable of preventing being damaged due to falling.

2. Discussion of the Related Art

The cell phone is an electronic product frequently used in daily life. An accident fall is difficult to avoid since the cell phone is carried and frequently used, and thus, the cell phone is possible to be damaged.

At present, a cell phone protective cover sleeving the cell phone is a common way for protecting the cell phone. However, the cell phone protective cover cannot block a screen, and only can wrap the back face or the side faces of the cell phone, and the effect of protecting the cell phone from being damaged is not ideal. Furthermore, the cell phone protective cover can protect the cell phone, while the appearance of the cell phone will be definitely affected, and the weight and the thickness of the cell phone are increased.

### SUMMARY

In view of the above-mentioned description, it is necessary to provide an impact-resistant cell phone which can be protected from being damaged due to falling.

The present invention provides an impact-resistant cell phone. The cell phone includes a body and a processor. The processor is arranged in the body. The body includes a display face and a back face opposite to the display face. The cell phone also includes a crash-proof protective part, a falling detection unit and an angular adjustment unit. The crash-proof protective part is arranged on the body. The falling detection unit and the angular adjustment unit are arranged in the body and respectively connected with the processor. The processor is used for receiving and processing information from the falling detection unit. And the angular adjustment unit is used for adjusting the spatial angle of the cell phone according to the control information transmitted from the processor.

The crash-proof protective part is arranged on the side faces at the lower part of the cell phone and the back face.

The falling detection unit includes an accelerometer.

The falling detection unit also includes a time counter.

The angular adjustment unit includes an air inlet, a gas compressor, a high-pressure gas storage cavity, gas injection pipelines and valves. The air inlet, the gas compressor and the high-pressure gas storage cavity are connected and sequentially communicated via a pipeline. The gas injection pipelines are communicated with the high-pressure gas storage cavity. And the valves are arranged on the gas injection pipelines.

The angular adjustment unit includes a gas generator, the gas injection pipelines and the valves. The gas injection pipe lines are communicated with the gas generator. And the valves are arranged on the gas injection pipelines,

The impact-resistant cell phone is provided with the crash-proof protective part resistant to crash, and components inside the cell phone are protected during falling and crash. The falling detection unit is arranged in the cell phone. The processor can be used for receiving and processing the information from the falling detection unit and judging whether the cell phone is falling or not. The angular adjustment unit is used for adjusting the spatial angle of the cell phone according to the control information transmitted from the processor. The crash-proof protective part resistant to impact first is led to strike the ground during falling of the cellphone. Therefore, other parts can be protected from being damaged and the cell phone is prevented from being damaged.

### BRIEF DESCRIPTION OF THE DRAWINGS

FIG. 1 is a front schematic view of an impact-resistant cell phone in accordance with the embodiment of the present invention.

FIG. 2 is a back schematic view of the impact-resistant cell phone in accordance with the embodiment of the present invention.

FIG. 3 is a structural diagram of a processor, a falling detection unit and an angular adjustment of the impact-resistant cell phone in accordance with the embodiment of the present invention.

FIG. 4 is a schematic view showing the adjustment of the spatial angle of the cell phone at a falling state in accordance with the embodiment of the present invention.

FIG. 5 is a schematic view showing the adjustment of the spatial angle of the cell phone at another falling state in accordance with the embodiment of the present invention.

FIG. 6 is a structural diagram of a processor, a falling detection unit and an angular adjustment of an impact-resistant cell phone in accordance with another embodiment of the present invention.

### DETAILED DESCRIPTION OF THE EMBODIMENTS

Further detail description on the impact-resistant cell phone of the embodiment of the present invention will be made with reference to the drawings and the embodiments.

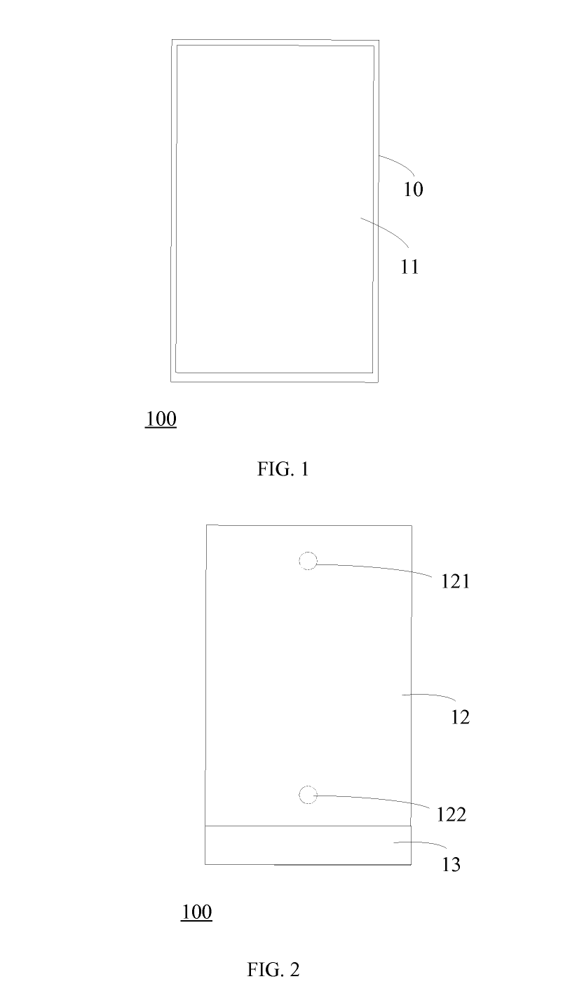

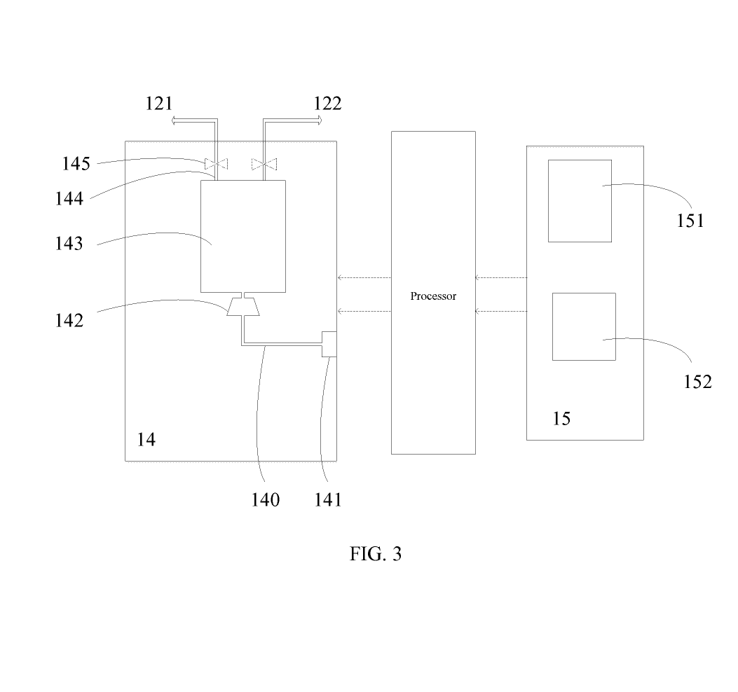

Referring to FIG. 1 to FIG. 3, an impact-resistant cell phone 100 of the embodiment of the present invention is shown. The cell phone 100 includes a body 10. The body 10 is provided with a display face 11, a back face 12 opposite to the display face 11 and four side faces (not labeled) connected between the display face 11 and the back face 12. A crash-proof protective part 13 is arranged on the body 10. A processor (not labeled), a falling detection unit 15 and an angular adjustment unit 14 are further arranged in the body 10. The falling detection unit 15 and the angular adjustment unit 14 are respectively connected with the processor. The processor is used for receiving information from the falling detection unit 15 so that whether the cell phone is judged to be at a falling state or whether the angular adjustment unit 14 is needed to start. If needed to start, the angular adjustment unit 14 can be used for rotating the spatial angle of the cell phone 100 according to the control information transmitted from the processor. Thus, the crash-proof protective part 13 of the body 10 can be led to face the ground (downwards) and be contacted and collided with the ground, and the cell phone is prevented from being damaged.

The processor can be a central processor of the cell phone, and definitely, another processing chip can be adopted.

The crash-proof protective part 13 can be made of a high-strength material. In the particular embodiment, the crash-proof protective part 13 is arranged on the side faces at the lower part of the cell phone 100 and the back face 12. It should be understood that the present invention should not be limited to this. In the other embodiments, the crash-proof protective part 13 can be arranged on the whole back face 12 or arranged on the side faces. Furthermore, the crash-proof protective part 13 also can be a replaceable part so as to further make the cell phone convenient and realize appearance versatility of the cell phone.

The falling detection unit 15 is used for judging the falling process of the cell phone 100. For example, when the cell phone 100 is judged to fall freely or fall freely at a limited speed and the crash-proof protective part 13 does not face the ground, the falling detection unit 15 can start the angular adjustment unit 14. The angular adjustment unit 14 rotates the directional angle of the cell phone in the space during falling. The crash-proof protective part 13 is led to face the ground, so that the crash-proof protective part 13 faces the ground, is contacted and collided with the ground and stands falling impact directly. As a result, components inside the cell phone 100 and a fragile display screen are protected, and the cell phone is prevented from being damaged.

The falling detection unit 15 can include an accelerometer 151. The accelerometer 151 can be used for detecting the accelerated speed, the acceleration direction of the cell phone and the spatial angle at which the cell phone is located currently, and sending the detected information to the processor, so that whether the cell phone 100 is judged to fall freely or not and the angle at which the cell phone 100 is needed to rotate is determined. Furthermore, the falling detection unit 15 also includes a time counter 152. The time counter 152 is used for recording falling time of the cell phone 100 and sending the information to the processor. With the arrangement of the time counter 152, the cell phone 100 can be controlled to fall after setting a certain time interval to start the angular adjustment unit 14. Therefore, the impact-resistant efficiency and effect of the cell phone 100 is further improved.

The angular adjustment unit 14 can include an air inlet 141, a gas compressor 142, a high-pressure gas storage cavity 143, gas injection pipelines 144 and valves 145. The air inlet 141, the gas compressor 142 and the high-pressure gas storage cavity 143 can be connected and sequentially communicated via a pipeline 140 The gas injection pipelines 144 are communicated with the high-pressure gas storage cavity 143. And the valves 145 are arranged on the gas injection pipelines 144. In the particular embodiment, two gas injection pipelines 144 are arranged, the valves 145 are arranged on the gas injection pipelines 144, the two gas injection pipelines 144 are respectively communicated with gas injection holes 121 and 122, and gas is injected out through the control of the valves 145. During use, air enters through the air inlet 141, is compressed to form high-pressure gas under the effect of the gas compressor 142 and is stored in the high-pressure gas storage cavity 143. When the processor judges that the cell phone is at the falling state, the processor can control the valves 145 to open so as to lead the high-pressure gas to inject out through the gas injection holes 121 and 122 according to different requirements. Thus, an acting force is provided for the cell phone 100, and the spatial angle of the cell phone 100 is changed during the falling of the cell phone 100. It should be understood that a certain amount of high-pressure gas can be stored in the high-pressure gas storage cavity 143 at a normal state and can be immediately used when an accident happens. Thus, the requirement of processing ability on equipment is reduced, and cost is further reduced.

Two gas injection holes can be contained and can be a first gas injection hole 121 at the upper part of the back face 12 of the cell phone 100 and a second gas injection hole 122 at the lower part of the back face 12 of the cell phone 100 respectively. The first gas injection hole 121 and the second gas injection hole 122 fulfill effects per se at different occasions according to the control of the processor. It should be understood that the present invention is not limited to this. In the other embodiments, one, three or more gas injection holes can be arranged, and can be arranged on the display face 11 or simultaneously on the display face 11 and the back face 12 according to the designs of a control structure and the appearance.

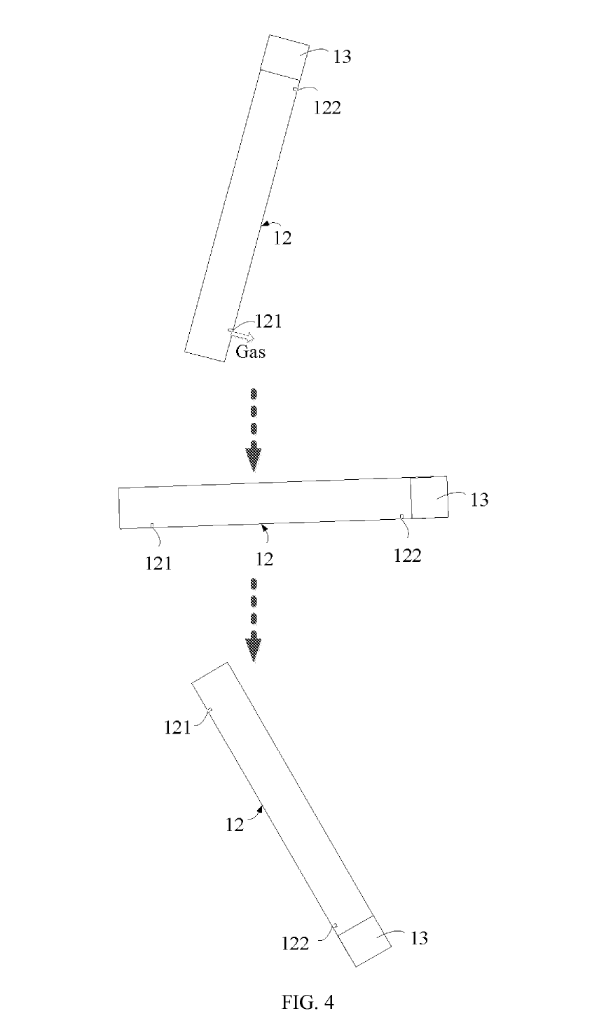

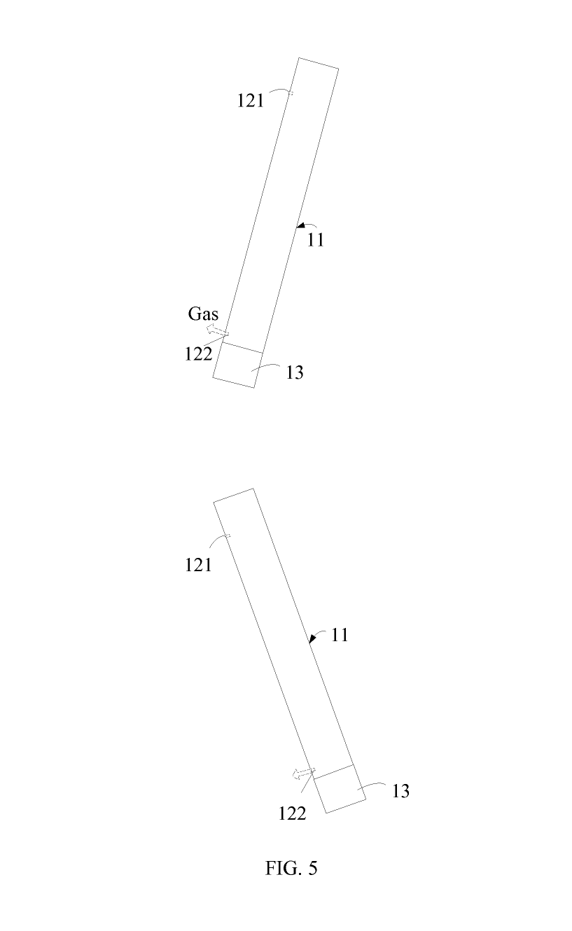

When the processor judges that the cell phone 100 is at the falling state according to the falling detection unit 15, the crash-proof protective part 13 is arranged above and the back face 12 faces downwards, the processor can control one of the valves 145, the high-pressure gas is led to inject out through the first gas injection hole 121 so as to adjust the falling angle of the cell phone as shown in FIG. 4. When the processor judges that the cell phone is at the falling state according to the falling detection unit 15, the crash-proof protective part 13 is arranged below and the display face 11 faces downwards, the processor can control one of the valves 145, the high-pressure gas is led to inject out through the second gas injection hole 122 so as to adjust the falling angle of the cell phone as shown in FIG. 5.

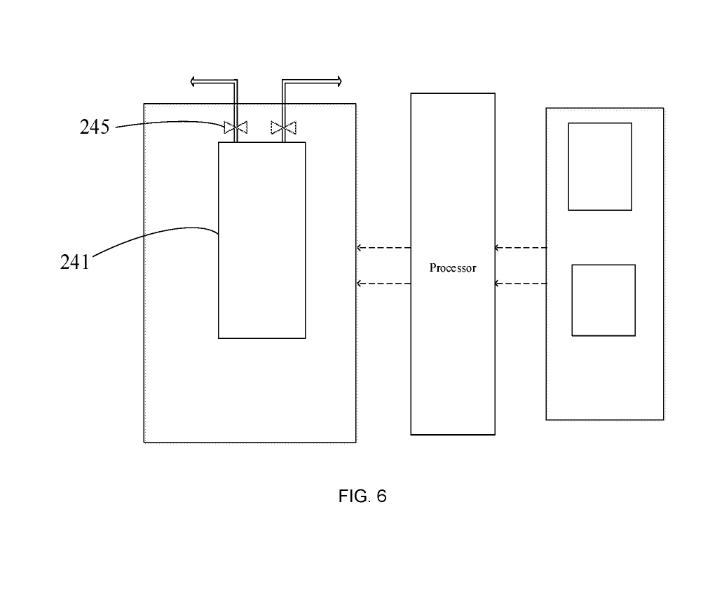

Furthermore, the angular adjustment unit 14 is not limited to the above-mentioned representation. Referring to FIG. 6, in another embodiment, the air inlet 141, the gas compressor 142 and the high-pressure gas storage cavity 143 can be replaced by a gas generator 241. The gas generator 241 can store a gas generation agent. During use, the gas generation agent is triggered to generate chemical reaction through the control of the processor so as to instantaneously generate a large quantity of gas, the gas injection quantity of injection pipelines are further controlled by valves 245, and the spatial angle of the cell phone during falling also can be changed.

The above description is only a better embodiment of the present invention, and is not intended to limit the present invention in any form. The present invention is not limited to, but disclosed as above with reference to the better embodiment. It will be understood by any those skilled in the art that equivalent changes such as slight alteration or modification in the equivalent embodiments can be made with reference to the above-disclosed technical content without departing from the scope of the technical scheme of the present invention. Any simple change, equivalent variation and modification of the above embodiment made in accordance with the technology of the present invention without departing from the content of the technical scheme of the present invention all belong to the scope of the technical scheme of the present invention.

1. An impact-resistant cell phone comprising:
a body having a display face and a back face opposite to the display face; and
a processor arranged in the body;
wherein the impact-resistant cell phone further comprises a crash-proof protective part, a falling detection unit and an angular adjustment unit, the crash-proof protective part is arranged on the body, the falling detection unit and the angular adjustment unit are arranged in the body and respectively connected with the processor, the processor is used for receiving and processing information from the falling detection unit, and the angular adjustment unit is used for adjusting the spatial angle of the cell phone according to control information transmitted from the processor;
wherein the angular adjustment unit comprises a gas generator, the gas injection pipelines and the valves, the gas injection pipe lines are communicated with the gas generator, and the valves are arranged on the gas injection pipelines.

2. The impact-resistant cell phone as claimed in claim 1, wherein the crash-proof protective part is arranged on side faces at the lower part of the cell phone and the back face.

3. The impact-resistant cell phone as claimed in claim 1, wherein the falling detection unit comprises an accelerometer.

4. The impact-resistant cell phone as claimed in claim 3, wherein the falling detection unit also comprises a time counter.

5. (canceled)

6. (canceled)
